(19) United States
(12) Patent Application Publication
(10) Pub. No.: US 2021/0146938 A1
(43) Pub. Date: May 20, 2021

(54) DEVICE AND METHOD FOR CONTROLLING A VEHICLE MODULE DEPENDING ON A STATUS SIGNAL

(71) Applicant: ZF Friedrichshafen AG, Friedrichshafen (DE)

(72) Inventor: Bülent SARI, Friedrichshafen (DE)

(73) Assignee: ZF Friedrichshafen AG, Friedrichshafen (DE)

(21) Appl. No.: 16/622,808

(22) PCT Filed: May 15, 2018
(86) PCT No.: PCT/EP2018/062497

§ 371 Date: Dec. 13, 2019

(30) Foreign Application Priority Data
Jun. 19, 2017 (DE) 10 2017 210 151.2

(51) Int. Cl. B60W 50/023; B60W 50/02; G06N 3/04; G06F 11/07; G06F 11/20

(52) U.S. Cl. CPC B60W 50/023; B60W 50/0205; G06N 3/04; B60W 2050/0215; G06F 11/2028; B60W 2050/021; G06F 11/0757

(57) ABSTRACT

The invention provides a device for controlling a vehicle module based on a status signal of a power processor that acquires and evaluates sensor signals. Based on the status signal of the power processor, the vehicle module is controlled with either the power processor or a fallback processor. The fallback processor enables an emergency operation of the vehicle module. Furthermore, a device for controlling a vehicle module with a safety processor is provided, via which the vehicle module is controlled with sensor signals evaluated by either the first or second power processor, based on a state of a first and second power processor. A driver assistance system process is also provided, in which one of the devices according to the invention is used.

### RELATED APPLICATIONS

This application is a filing under 35 U.S.C. § 371 of International Patent Application PCT/EP2018/062497, filed May 15, 2018, claiming priority to German Patent Application 10 2017 210 151.2, filed Jun. 19, 2017. All applications listed in this paragraph are hereby incorporated by reference in their entireties.

### TECHNICAL FIELD

The invention relates to a device for controlling a vehicle module, a device for controlling a vehicle, and a driver assistance system process, in which a device according to the invention is used.

### BACKGROUND

A vehicle module is a component of a vehicle. By way of example, a vehicle steering wheel is a vehicle module. Electrical/electronic systems, abbreviated as E/E systems, are likewise vehicle modules. Functional units that may be composed of numerous components form a vehicle module. Vehicle modules are controlled and regulated with control units.

Control units, also referred to as “electronic control units,” abbreviated as ECUs, are electronic components for controlling and regulating. In the automotive field, ECUs are used in numerous electronic fields for controlling and regulating vehicle functions. ECUs that control and regulate numerous related functions are called “domain ECUs.” Vehicle domains that form a functional unit and in which there are related functions are called “vehicle domains.” Examples of vehicle domains are the infotainment system, the chassis, the drive, the interior, and safety. Functions for the infotainment system include operating a radio, a CD player, establishing a telephone connection, a connection to a hands-free telephone, etc. When a music CD is playing, for example, the music is paused when a telephone connection is established.

For a control unit in a vehicle module, shutting off the control unit in the event of a malfunction is dangerous, because this results in at least one critical operating phase of the control unit, in which one or more safety objectives, as defined in the ISO 26262 standard, are impaired through shutting it off. Error tolerance measures must therefore be provided for functional safety reasons, which at least enable an emergency operation if the control unit fails. Systems that enable an emergency operating mode in the event of a malfunction are referred to as “fail operational systems.” A fail operational system is configured such that if it is assumed that there is a malfunctioning region within the critical operating phase, the necessary remaining range of functions can maintain functionality.

### SUMMARY

The fundamental object of the invention is to provide a device for controlling a vehicle module, and a driver assistance system process in which such a device is used, which is safer than that in the prior art, in particular a fail operational system for such a device.

This object is achieved with a device for controlling a vehicle module that has features as disclosed herein, and with a driver assistance system process that has features as disclosed herein.

Advantageous embodiments and developments are also described herein.

The device according to the invention for controlling a vehicle module contains a control interface, wherein the vehicle module can be controlled via the control interface, at least one first power processor that is configured to acquire and evaluate sensor signals, at least one first monitoring device that is connected to the first power processor such that the first monitoring device outputs a monitoring signal to a fallback processor core, based on a status signal of the first power processor, wherein the fallback processor core is connected to the first monitoring device such that the fallback processor core is actuated via the control interface for at least an emergency operating mode, based on a status signal of the vehicle module.

An interface is a device between at least two functional units at which an exchange of logical values, e.g. data, or physical values, e.g. electrical signals, takes place, either unidirectionally or bidirectionally. The exchange can be analog or digital. An interface can exist between software and software, hardware and hardware, as well as software and hardware, and hardware and software.

A processor is an electronic circuit that receives and processes commands. The processor can control and regulate other circuits with the results of the processing of commands, thus advancing a process.

A part of the processor is referred to as a core, which forms a computing unit this is capable of executing one or more commands.

A monitoring system, also known as a “watchdog,” is a component of a system that monitors the functioning of other components, in this case the power processor. If a possible error has been detected, this is either indicated in accordance with a safety provision, or a suitable jump instruction is issued that resolves the pending problem. The term “watchdog” comprises both hardware watchdogs and software watchdogs. A hardware watchdog is an electronic component that communicates with the component that is being monitored. The software watchdog is a testing software in the component that is to be monitored that checks whether all of the important program modules are correctly executed in a predefined time period, or whether a module requires too much time for the processing. The software watchdog can be monitored by a hardware watchdog. As an alternative to a software watchdog, a software can be monitored with a counter, which is set to a specific value at regular intervals by the software, and continuously decremented by the hardware. If the counter reaches a value of zero, the software has not reset the counter in time, meaning that the software is not working properly. Watchdogs can be implemented in particular in safety-relevant applications, and enable a monitoring of E/E systems for compliance with ISO 26262.

A status signal in the first power processor contains information regarding the hardware and/or software status of the first power processor. By way of example, a hardware watchdog detects whether the first power processor has responded before a predefined time has elapsed as the status signal, similar to the principle of a kill switch. The response occurs in a flawless state, and in a defective state, there is no response. As a result, it is possible to determine whether the first power processor is malfunctioning. A monitoring signal of the first monitoring device contains information regarding whether or not the monitored component is functioning properly. In the above example the monitoring signal confirms that a response has occurred in a functioning state, and that no response has occurred in a malfunctioning state. By way of example, the monitoring signal has a value of one if the response occurs, and a value of zero if there is no response.

Emergency operation comprises operation of the vehicle module in a malfunctioning state, which is initiated based on the status signal. In an emergency operating mode, only those vehicle functions that are necessary for the vehicle to function safely are maintained. In particular, the fallback processor core controls the vehicle module with only the sensor signals that are necessary for the vehicle to function safely. If, for example, an error is detected while driving on a freeway, only those vehicle functions that enable a safe driving and parking of the vehicle are maintained, and the vehicle module is only controlled with the sensor signals that enable this. As a result, it is not possible to continue driving for a greater distance, and instead, it is only possible to drive until reaching a safe state.

If the monitoring device detects a malfunctioning state in the first power processor, i.e. the monitoring signal has a value of zero, for example, the vehicle module is controlled by the fallback processor core via the control interface. The first power processor is preferably deactivated by the monitoring device, and at the same time the fallback processor core is activated. As a result, it is ensured that if the first power processor malfunctions, the vehicle module can continue to operate in an emergency operating mode.

The device advantageously has a first signal channel and a redundant second signal channel for conducting the sensor signals to the device, wherein the sensor signals can be conducted to the first power processor in the first signal channel, and to the fallback processor in the second signal channel. If the first signal channel malfunctions, it is thus ensured that the sensor signals can be forwarded to the fallback processor core, which enables an emergency operation of the device with these sensor signals.

According to one development of the invention, the device has a monitoring processor core for monitoring the sensor signals, which is connected to the fallback processor core such that sensor signals output by the monitoring processor core can be input in the fallback processor core. The monitoring processor core is an autonomous computing unit, in contrast to the monitoring device, and represents a further safety measure for activating the fallback processor core. In particular, the monitoring processor core checks whether the sensor signals are in their respective validity ranges. The monitoring processor core also detects short circuits and ground contacts in circuitry.

The first power processor is preferably configured to acquire and evaluate sensor signals from numerous sensors, wherein the sensor signals of any one sensor can be acquired and evaluated in the first power processor, in particular independently of the sensor signals from another sensor. This has the advantage that a failure in the acquisition and/or evaluation of a sensor signal does not affect the acquisition and/or evaluation of another sensor signal from another sensor, such that there are no interdependent failures.

According to another embodiment of the invention, the fallback processor core and/or a monitoring processor core are cores in a safety processor, wherein the control interface is located between the safety processor and the vehicle module. The safety processor is therefore a multicore processor in which numerous cores are located on a single chip, i.e. a semiconductor element. Multicore processors achieve a higher computing power and are less expensive to implement in a chip than multicore processors in which each individual core is located in a processor socket, and the individual processor sockets are located on a main circuit board. The safety processor is also referred to as a “multicore micro control unit,” abbreviated as a multicore MCU.

Advantageously, there is at least one, in particular redundant, information interface between the first power processor and the safety processor, for forwarding the evaluated sensor signals from the first power processor to the safety processor. Redundancy is the additional presence of functionally identical or comparable resources in a technological system, when these are not normally needed if the device is functioning properly. As a result, if an information interface fails, there is an additional information interface available.

The safety processor is preferably configured to check the evaluated signals for plausibility, in order to control the vehicle module with information determined to be plausible. Plausibility control is a method with which the value, or a result, in general, is checked in general to determine whether or not it can be at all plausible, i.e. acceptable, evident, and/or reproducible. Plausibility controls can be executed in both hardware and in software. Plausibility controls in hardware are limited to the monitoring of signals, for example, that can only occur in specific combinations and sequences. By way of example, measurement values can be checked with regard to their plausible value range and their temporal course. In software engineering, the plausibility of a variable is checked in terms of whether it belongs to a specific type of data, or lies within a predefined value range or a predefined quantity. The plausibility control is an additional measure with which it can be advantageously determined whether the sensor signals evaluated by the first power processor are plausible with respect to one another.

The safety processor has a second monitoring device, in particular for the fallback processor core and the monitoring processor core. It is advantageously possible with the second monitoring device to monitor not only the first power processor and the safety processor, but also the fallback processor core and the monitoring processor core, in particular regarding hardware and/or software.

The power processor and/or the safety processor preferably have a redundant power supply, in particular for both the fallback processor core and the monitoring processor core. This has the advantage that if the power supply fails, there is a redundant power supply available for preventing a malfunction of the power processor and/or the safety processor due to a power failure.

In a particularly preferred embodiment of the invention, a control unit contains a device according to the invention. Preferably, a domain ECU has a device according to the invention. In particular, an ADAS domain ECU has a device according to the invention. An ADAS domain ECU is a domain ECU for a driver assistance system, also referred to as an advanced driver assistance system, abbreviated ADAS. As a result, the invention provides a safety architecture, in particular in the form of a fail operational system for the ADAS domain ECUs.

The other device according to the invention for controlling a vehicle module has a control interface, wherein the vehicle module can be controlled via the control interface, a first power processor, which is configured to acquire and evaluate sensor signals, at least one second power processor, which is configured to acquire and evaluate sensor signals, and a safety processor, which is connected to the first power processor and the second power processor such that the safety processor controls the vehicle module based on a result of the evaluation of sensor signals with the first power processor and a result of the evaluation of sensor signals with the second power processor. The safety processor determines whether the first and second power processors have evaluated the sensor signals correctly, or whether one of the power processors is malfunctioning, based on the results of the evaluated sensor signals. If the first power processor is malfunctioning, the safety processor controls the vehicle module with the sensor signals evaluated in the second power processor. If the second power processor is malfunctioning, the safety processor controls the vehicle module with the sensor signals evaluated in the first power processor. Such a device has the advantage that if the first power processor malfunctions, all of the sensor signals evaluated by the second power processor are used for controlling the vehicle module, and vice versa. Therefore, if the first power processor malfunctions, it is not only possible to operate the vehicle module in an emergency operating mode, but also in a normal operating mode. The second power processor is redundant to the first power processor. Each additional redundant power processor also increases the safety.

The first power processor preferably acquires the sensor signals via a first signal channel and the second power processor acquires the sensor signals via a second signal channel.

There is preferably an information interface between both the first power processor and the second power processor, and the safety processor, in particular one information interface in each case, for forwarding the information evaluated in the first power processor and the second power processor to the safety processor.

The safety processor particularly preferably has at least a first core, a second core, and a third core, wherein the first core is connected to the power processor such that the first core implements the sensor signals evaluated by the first power processor, the second core is connected to the second power processor such that it implements the sensor signals evaluated by the second power processor, and wherein the third core is configured to compare a result of the implementation of the sensor signal implemented on the first core with the result of the implementation of the sensor signal implemented on the second core, wherein the vehicle module can be controlled based on the results of the comparison. A malfunctioning state of the first power processor and/or the second power processor can be determined by the comparison. It is therefore possible to detect a malfunctioning of a power processor with the third core of the power processor, and to control the vehicle with the sensor signals evaluated by the power processor that is functioning correctly.

The device preferably has a redundant power supply, in particular for the first power processor, the second power processor, and the safety processor.

According to one development of the invention, the first core, second core, and third core of the safety processor each have a redundant power supply.

A control unit with the other device according to the invention is a preferred embodiment of the invention. A domain ECU preferably has the other device according to the invention. In particular, an ADAS domain ECU has the other device according to the invention. An ADAS domain ECU is a domain ECU for a driver assistance system, also referred to as an advanced driver assistance system, abbreviated ADAS. As a result, the invention provides a safety architecture, in particular in the form of a fail operational system for ADAS domain ECUs.

In a particularly preferred embodiment of the invention, the first power processor and/or the second power processor exhibit artificial intelligence, wherein the artificial intelligence is configured to evaluate sensor signals acquired by the first power processor and/or the second power processor to obtain information for controlling the vehicle module.

Artificial intelligence means an intelligence that is similar to human intelligence is reproduced, i.e. it is attempted to build or program a computer that can autonomously process problems. Artificial intelligence can be implemented in particular with artificial neural networks. An artificial neural network is an algorithm executed on an electronic circuit and is programed based on the neural network of the human brain. Functional units of an artificial neural network are artificial neurons, the output of which results in general in a value of an activation function evaluated over a weighted sum of the inputs plus a systematic error, the so-called bias. Artificial neural networks are taught or trained by testing numerous predetermined inputs with various weighting factors and activation functions, in a manner similar to that of the human brain. The training of an artificial intelligence using predetermined inputs is referred to as machine learning. A subset of machine learning is deep learning, so-called deep learning, in which a series of hierarchical layers of neurons, the so-called hidden layers, are used for executing the process of machine learning.

The first power processor and/or second power processor are preferably configured to acquire sensor signals from environment detection sensors, in particular a camera, a radar, and/or a lidar. As a result, it is possible to control vehicle modules based on the signals detected by the environment detection sensors, which is necessary for autonomous driving in particular.

In another embodiment of the invention, the first power processor and/or the second power processor have a control device, wherein the control device is configured to monitor the environment recorded by the environment detection sensors. The environment detection sensors may comply with ISO 26262 as E/E systems, and thus function safely, but it may be the case that the environment is misunderstood by the environment detection sensors, thus forming a further safety risk. Such a safety risk, based on a misinterpretation of the environment, cannot be derived from ISO 26262. It is, however, also possible to check whether the environment detection sensors have correctly understood the environment with the control device. This ensures a so-called “safety of the intended functions,” abbreviated SOTIF. The environment detection sensors record the environment, thus producing a great deal of data. The objects, or other useful information such as the distance to an obstacle, that are essential for autonomous driving, are generated from this data with appropriate algorithms. The challenge is to correctly generate useful information from these data. If there is a hardware or software failure in the power processor, or a systematic error in an algorithm, there is a greater danger of generating a situation critical to safety through the incorrectly detected environment. The redundancy of the power processor serves to maintain the system in such cases, and thus remain fail operational.

The vehicle module preferably relates to a vehicle domain, in particular infotainment, the chassis, drive, interior, and/or safety. In the case of the drive and/or chassis, the vehicle module can be controlled via actuators, in particular mechanical actuators. In the infotainment domain, the vehicle module can be actuated acoustically and/or visually. In the interior domain, the vehicle module can also be actuated hapticly, e.g. in a lane maintaining assistance system, causing the steering wheel to vibrate.

A driver assistance system also lies within the scope of the invention, which has one of the devices according to the invention.

The driver assistance system process according to the invention, in which one of the devices according to the invention is used, comprises the following steps:
acquiring sensor signals from at least one environment detection sensor in at least the first power processor,
evaluating the sensor signals to obtain information for controlling the vehicle module,
monitoring a state of the first power processor and outputting a monitoring signal based on the state of the first power processor,
controlling the vehicle module with the fallback processor for an emergency operation of the vehicle module based on the monitoring signal.

It is therefore possible with the driver assistance system process to continue to operate the vehicle module, at least in an emergency operating mode, if a malfunction has been detected.

Advantageously, the vehicle module is controlled with a second power processor. This enables a normal operation of the vehicle module if the first power processor fails.

In a preferred embodiment, the first power processor and/or the second power processor have a control device, wherein the control device monitors the environment recorded by the environment detection sensors.

### BRIEF DESCRIPTION OF THE DRAWINGS

The invention shall be explained below in reference to the following figures. Therein:

FIG. 1 shows an exemplary embodiment of a device according to the invention for controlling a vehicle module,

FIG. 2 shows an exemplary embodiment of another device according to the invention for controlling a vehicle module,

FIG. 3 shows another exemplary embodiment of a device according to the invention for controlling a vehicle module, and

FIG. 4 shows an exemplary embodiment of a driver assistance system process according to the invention.

If not otherwise indicated, identical reference numerals refer to identical components that have the same functions in the figures. For purposes of clarity, only the respective relevant components are numbered in the individual figures.

### DETAILED DESCRIPTION

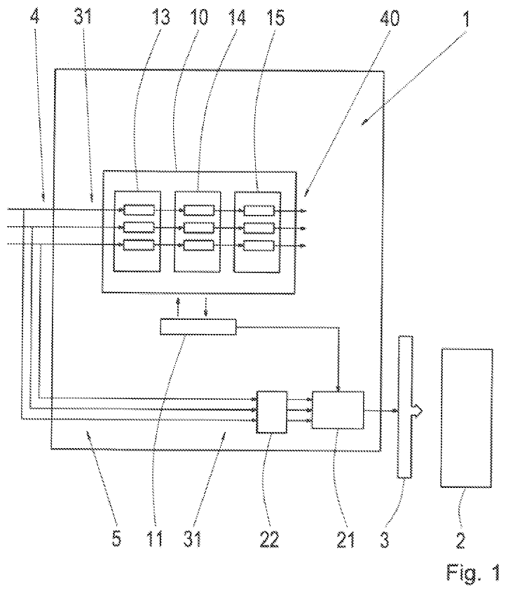

The device 1 in FIG. 1 for controlling a vehicle module has a first power processor 10 and a fallback processor core 21. Sensor signals 31 are conducted in a first signal channel 4 of the device 1 to the first power processor 10, and in a second signal channel 5 to the fallback processor core 21. The sensor signals 31 can be signals from environment detection sensors, e.g. a camera, radar, or lidar.

The state of the first power processor 10 is detected by a first monitoring device 11 by means of a status signal of the first power processor. The first monitoring device 11 checks, e.g., whether the first power processor functions correctly with respect to hardware, or whether the software for evaluating the acquired sensor signal 31 functions correctly and outputs a corresponding monitoring signal. A malfunctioning state of the first power processor can be determined on the basis of the monitoring signal. When the first monitoring device 11 detects a malfunctioning state of the first power processor, the first monitoring device 11 can activate the fallback processor core 21, which enables it to actuate the vehicle module 2 for an emergency operating mode via the control interface 3.

When the first power processor 10 is functioning properly, the sensor signals 31 are evaluated by the first power processor 10 to obtain information 40. The vehicle module 2 is controlled with the information 40 via the control interface 3. Controlling with information 40 also means that with more information 40, a fusion of the information first takes place, and the vehicle is controlled with the information 40 from the fusion, or with the information 40 itself.

The power processor 10 has a control device 13, a data acquisition device 14 and an evaluation unit 15 for evaluating the sensor signals 31. The control device 13 checks whether the sensor signals 31 have correctly reproduced an environment. The sensor signals 31 that correctly reproduce an environment are accumulated in the data acquisition device 14, and subsequently evaluated in the evaluation unit 15.

The evaluation unit 15 exhibits artificial intelligence that can identify traffic-relevant objects in camera images, for example, e.g., pedestrians, other vehicles, or traffic signs. The information 40 evaluated in this manner is sent to a control interface 3, which generates corresponding commands for controlling the vehicle module 2.

A monitoring processor core 22 is also shown in FIG. 1, which has an input to which the sensor signals 31 are sent. Sensor signals 31 monitored by the monitoring processor core 22 then form the input for the fallback processor core 21.

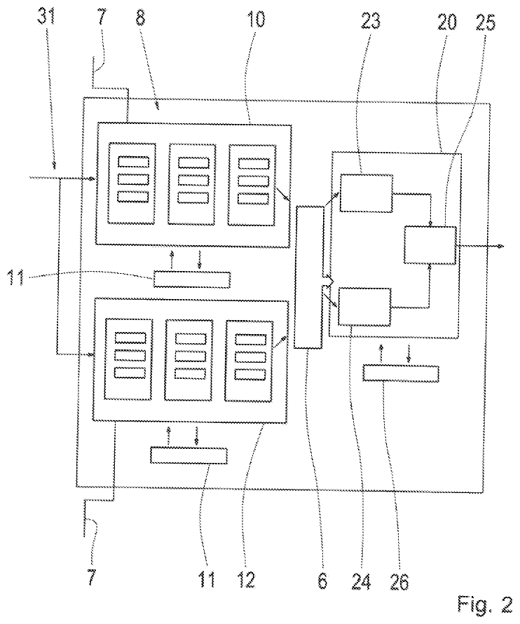

FIG. 2 shows a device 8 that has a second power processor 12 in addition to the first power processor 10. The sensor signals 31 are redundantly supplied to the first power processor 10 and the second power processor 12.

The first power processor 10 and the second power processor 12 are each monitored by a monitoring device 11.

The device 8 also has a safety processor 20. The safety processor 20 receives the information 40 evaluated by the first power processor and the second power processor via the information interface 6.

The safety processor has a first core 23, which processes the evaluated information 40 of the first power processor 10. The safety processor 20 also has a second core 24, which processes the evaluated information of the second power processor. The results of the processing of the information 40 evaluated in the first core 23 and second core 24 by the safety processor are forwarded to a third core 25 of the safety processor and compared with one another in the third core 25. In a comparison, the third core 25 determines whether the first power processor 10 and the second power processor 12 are each functioning correctly, or whether one of the power processors 10, 12 is malfunctioning.

If the first power processor 10 is malfunctioning, only the information 40 evaluated by the second power processor 12 is used by the third core 25 of the safety processor 10 for controlling the vehicle module 2. The same applies respectively if the second power processor 12 is malfunctioning.

As a further safety measure, the safety processor 20 also has a second monitoring device 26.

The first power processor 10 and the second power processor 12 are also each connected to a redundant power supply 7.

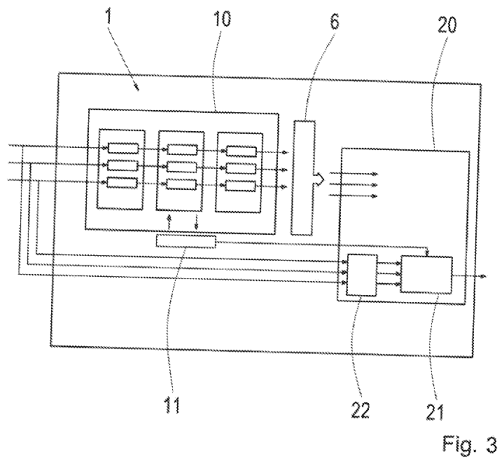

FIG. 3 shows that the fallback processor core 21 and the monitoring processor core 22 of the device 1 can also be cores of a safety processor 20.

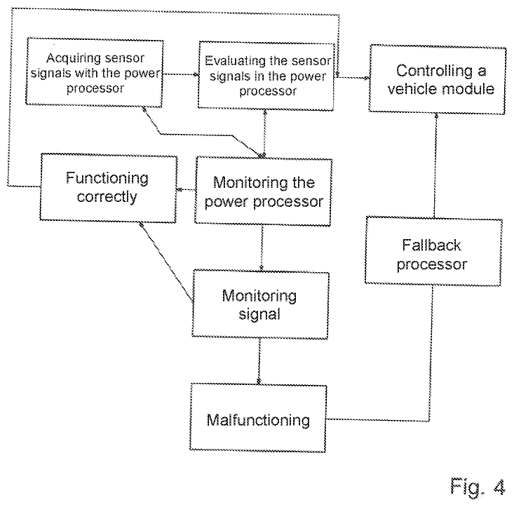

A vehicle module can be actuated for an emergency operating mode with the driver assistance system process shown in FIG. 4. Sensor signals 31 are acquired and processed in a power processor 10. The vehicle module 2 is controlled via the control interface 3 with the evaluated sensor signals 31.

The acquisition and evaluation process is monitored by the monitoring device 11. By way of example, the power processor 10 sends a signal with a predefined value and/or predefined temporal course to the monitoring device 11 at regular time intervals when it is functioning correctly. This signal is the status signal for the power processor 10. If the power processor is malfunctioning, whether it is a hardware and/or a software failure, the status signal can differ from the predefined value and/or predefined temporal course, or the power processor 10 does not send a status signal to the monitoring device 11.

The monitoring device 11 outputs a monitoring signal based on this status signal. If, for example, the monitoring device 11 receives a status signal with the predefined value, the monitoring signal can be the number 1, which then indicates a properly functioning state of the power processor 10. If the monitoring device 11 does not receive a status signal in a predefined time interval, the monitoring signal can be the number 0, which then indicates a malfunctioning state of the power processor.

If the monitoring device 11 determines that the power processor 10 is functioning correctly, i.e. the monitoring signal is the number 1, the vehicle module 2 is then controlled with the sensor signals 31 evaluated in the power processor 10. If the monitoring device 11 determines that the power processor 10 is malfunctioning, i.e. the monitoring signal is the number zero, for example, the vehicle module is then controlled with the fallback processor 21.

### REFERENCE SYMBOLS

1 device
2 vehicle module
3 control interface
4 first signal channel
5 second signal channel
6 information interface
7 redundant power supply
8 device
10 first power processor
11 first monitoring device
12 second power processor
13 control device
14 data acquisition device
15 evaluation unit
20 safety processor
21 fallback processor core
22 monitoring processor core
23 first core
24 second core
25 third core
26 second monitoring device
30 sensor
31 sensor signal
40 information

1. A device for controlling a vehicle module, comprising:
a control interface configured to interface with the vehicle module such that the vehicle module can be controlled via the control interface;
at least one first power processor configured to acquire and evaluate sensor signals;
at least one first monitoring device coupled to the first power processor and configured to output a monitoring signal based on a status signal of the first power processor; and
at least one fallback processor core coupled to the first monitoring device and configured to control the vehicle module via the control interface for at least an emergency operating mode, based on the monitoring signal.

2. The device according to claim 1 further comprising:
a first signal channel and a redundant second signal channel for conducting the sensor signals to the device, wherein the sensor signals can be sent to the first power processor via the first signal channel, and the sensor signals can be sent to the fallback processor core via the second signal channel.

3. The device according to claim 1, further comprising:
a monitoring processor core configured to monitor the sensor signals and output the sensor signals, wherein the monitoring processor core is coupled to the fallback processor core such that sensor signals output by the monitoring processor core are input to the fallback processor core.

4. The device according to claim 1, wherein the first power processor is configured to:
acquire and evaluate the sensor signals from numerous sensors; and
acquire and evaluate a first sensor signal of the sensor signals from a first sensor independently of a second sensor signal of the sensor signals from a second sensor.

5. The device according to claim 3, wherein at least one of the fallback processor core or a monitoring processor core are safety processor cores, and wherein the control interface is located between the safety processor and the vehicle module.

6. The device according to claim 5, further comprising:
a second information interface located between the first power processor and the safety processor and configured to forward evaluated sensor signals from the first power processor to the safety processor.

7. The device according to claim 5, wherein, the safety processor is configured to check evaluated sensor signals from the first power processor for plausibility.

8. The device according to claim 5, wherein the safety processor has a second monitoring device configured to monitor the fallback processor core and the monitoring processor core.

9. The device according to claim 5, wherein at least one of the power processor the safety processor are coupled to a redundant power supply.

10. (canceled)

11. A device for controlling a vehicle module, comprising:
a control interface configured to interface with the vehicle module such that the vehicle module can be controlled via the control interface;
a first power processor configured to acquire and evaluate sensor signals;
at last one second power processor configured to acquire and evaluate the sensor signals; and
a safety processor coupled to the first power processor and the second power processor and configured to control the vehicle module based on a first evaluation result of the sensor signals evaluated with the first power processor and a second evaluation result of the sensor signals evaluated with the second power processor.

12. The device according to claim 11, further comprising an information interface located between the first power processor and the safety processor, and between the second power processor and the safety processor, the information interface configured to forward the first evaluation result from the first power processor and the second evaluation result from the second power processor to the safety processor.

13. The device according to claim 11, wherein the safety processor comprises: has
at least one first core;
at least one second core; and
at least one third core;
wherein the at least one first core is connected to the first power processor such that the at least one first core implements the first evaluation result from the first power processor,
wherein the at least one second core is connected to the second power processor such that the second core implements the second evaluation result from the second power processor, and
wherein the at least one third core is configured to compare a result of the implementation of the first evaluation result implemented on the first core with a result of the implementation of the second evaluation result implemented on the second core, wherein the vehicle module is controlled, at least in part, on a basis of a result of the comparison.

14. The device according to claim 11, further comprising a redundant power source for at least one of the first power processor, the second power processor, and the safety processor.

15. (canceled)

16. (canceled)

17. The device according to claim 11, wherein the first power processor and the second power processor execute artificial neural networks configured to evaluate the sensor signals to obtain information for controlling the vehicle module.

18. The device according to claim 11, wherein the first power processor and the second power processor are configured to acquire the sensor signals from environment detection sensors comprising at least one of a camera, a radar system, or a lidar system.

19. The device according to claim 18, wherein the first power processor and the second power processor each comprise a control device configured to monitor an environment recorded by the environment detection sensors.

20. The device according to claim 11, wherein the vehicle module corresponds to at least one of a chassis domain, drive, an interior domain, or a safety domain.

21. (canceled)

22. A driver assistance method comprising:
acquiring sensor signals from at least one environment detection sensor in at least a first power processor;
evaluating the sensor signals in the first power processor to obtain information for controlling a vehicle module;
monitoring, by a first monitoring device coupled to the first power processor, a state of the first power processor and outputting, by the first monitoring device, a monitoring signal based on the state of the first power processor; and
controlling the vehicle module with a fallback processor coupled to the first monitoring device for an emergency operating mode of the vehicle module based on the monitoring signal.

23. The driver assistance method according to claim 22, further comprising:
controlling the vehicle module with a second power processor in response to the first power processor becoming deactivated.

24. The driver assistance method according to claim 22, further comprising:
checking, by a control device of the first power processor, the sensor signals prior to the first power processor acquiring the sensor signals, to determine whether the environment detection sensors have correctly recorded an environment.
